(19) United States
(12) Patent Application Publication
(10) Pub. No.: US 2007/0130462 A1
(43) Pub. Date: Jun. 7, 2007

(54) Asynchronous encryption for secured electronic communications

(76) Inventors: Eric Chun Wah Law, San Jose, CA (US); Lap Man Yam, Los Altos Hills, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/376,769

(22) Filed: Mar. 15, 2006

Related U.S. Application Data
(60) Provisional application No. 60/748,111, filed on Dec. 6, 2005.

(51) Int. Cl. H04L 9/00

(52) U.S. Cl. 713/168

(57) ABSTRACT

An asynchronous communication system and method are configured for secured communication between a sender and a recipient without a need for pre-arrangement of shared static encryption key secrets. In one embodiment a system receives an initiation request for authentication from a sender seeking to transmit a message. The system generates an asymmetric key set, which includes a private key and a public key associated with a key reference. The system stores the private key with the key reference and transmits the public key to the sender. The sender uses the public key to encrypt the message to be sent to the recipient. The system will then receive a request for the private key from a recipient of the encrypted message. The system will authenticate the recipient identity. Once authenticated, the system transmits the private key to the recipient, which uses the private key to decrypt the encrypted message.

### CROSS REFERENCE TO RELATED APPLICATIONS

This application claims the benefit of U.S. Provisional Application No. 60/748,111, filed Dec. 6, 2005, which is incorporated by reference in its entirety.

This application is related to U.S. Patent Application No. ______, filed Mar. 15, 2006, titled “Single One-Time Password Token with Single PIN For Access To Multiple Providers”, which claims the benefit of U.S. Provisional Application No. 60/748,061, filed Dec. 6, 2005, and titled “Single One-Time Password Token with Single PIN For Access To Multiple Providers”, the contents of each is incorporated by reference in its entirety.

### BACKGROUND

1. Field of the Art

The present invention generally relates to the field of electronic communications, and more specifically, to asynchronous encryption for secured electronic communications.

2. Description of the Related Art

The Internet has demonstrated exponential growth in the last 10 years. Today, hundreds of millions of users are relying on the Internet to communicate, to work and to do business. Unfortunately, the current means to identify individuals and businesses and to protect communication and business transactions are primitive and piece-meal. Most commercial identity and data security measures on the market are complicated and difficult to use. Consequently, the acceptance of employing security schemes has been limited to the niche market of corporate applications. User identity, communication and transactions by the general public are at high risk any time a user signs on to the Internet. Unauthorized monitoring may violate privacy rights of individuals. Moreover, individuals are vulnerable to identity theft and fraud.

Everyday a massive volume of personal communications and online transactions such as email and on-line trading are still sent in clear form over the Internet. Even though the supply of encryption and authentication solutions in the market is plentiful, the complexity of the technology and the lack of security awareness by individual users are keeping those solutions from widely deployed. Internet users have resorted to communicate and to do business without protection. As a result, sensitive personal information and business transactions are subject to unnecessary risk exposure. As hacking tools such as viruses, spy-wares, proxies and network analyzers are getting more and more sophisticated, more and more Internet users are falling into victims of identity theft and fraudulent transactions.

However, it is also well recognized that physical mail and electronic mail are indispensable forms of communication for work and personal purposes. The amount of sensitive personal information and commercial secrets to be transferred by courier and online means are substantial. Hence, it is not uncommon to read news reports about commercial secrets being leaked during communication transit. For example, in July 2005 it was widely reported that over 40 million credit card accounts were exposed to potential fraud due to security breach by a third party processor of payment card transaction. End-to-end data encryption software would minimize the leakage and exposure of sensitive data in human readable form (i.e., in “clear form”). Incidents like these have increased user awareness of privacy and security and more people and organizations are taking closer look at data options such as encryption.

Nevertheless, current data encryption software packages tend to be too technical for the average user to understand. Besides poor usability, the key problem of data encryption is that it requires common encryption key secrets to be shared or distributed between the sender and the recipient before data encryption and decryption can be carried out successfully. This makes data encryption software cumbersome and difficult to use. Even if the sender is familiar with the encryption tool, it is often the case that a recipient lacks equal familiarity with the same tool. As a result, the parties often elect to drop such secured mechanisms in the interest of forging ahead with communications between them. Over time, anticipated widespread use of data encryption to protect data transmission wanes.

For those that use data encryption, the most common, and simplest, form of encryption is password-based encryption. Here, the sender uses a piece of encryption software to encrypt a data file with a pre-defined password. The sender can then send the encrypted data file to the recipient using email or physical means. When the recipient receives the encrypted data file, the recipient contacts the sender using conventional means such as a telephone to get encryption password information. The recipient then uses the same encryption software and enters the encryption password to decrypt the data file.

The shortcoming of this method is that most users often do not protect the encryption password. For example, they send the password in the same package or email to the recipient, thus making encryption totally useless. Next, the static password can be hacked relatively easily using automated password guessing software. Simple password file encryption is breakable because most users tend to use common vocabulary and hackers typically have virtually unlimited time when the encrypted file is obtained.

A slightly more sophisticated encryption method is public key cryptography (PKI). In this case, the sender and the recipient must apply their own digital certificates where each certificate contains a public key and a private key. To encrypt a data file, the sender uses the public key of the recipient. To digitally sign the same data file, the sender uses one's private key. To decrypt a data file, the recipient uses one's private key. To verify the sender's identity, the recipient uses the sender's public key.

The PKI method looks theoretically elegant, but in practice it is quite difficult for most users to apply. The sender and the recipient must understand the basic concept of public key cryptography and certificate authority and must have the same encryption software. Moreover, for more robust security, public key cryptography recommends the use of a tamper-resistant hardware token to create and store the digital certificate and a standard for tamper-resistance that is FIPS-140-1 level 2 and above. However, the additional piece of hardware increases usability burdens on a user. For example, if the token is a smart card, the user must have a smart card reader installed in their personal computers. Thus, while PKI may be acceptable in the corporate world for computer-to-computer data security, it is too cumbersome for everyday uses in business and personal communication.

Some encryption software vendors have attempted to enhance usability by hiding the complexity of the certificate authority and avoiding the use of hardware token for storing digital certificate. However, the use of software token application, such as with PGP software, in the personal computer has increased the risk of exposing private keys of a user. This reduces the overall security level. Further, despite attempts by encryption software packages to enhance usability, the requirement to have pre-arrangement of key secrets deters widespread popularity of data encryption for everyday use. Thus, besides poor usability another overarching factor in the shortcomings of these encryption software packages is a need for pre-arrangement of static and shared encryption key secrets.

Therefore, there is a need for a system and process to allow a sender of an electronic communication to encrypt electronic contents that can only be decrypted by an intended recipient without a need to present keys between the sender and the intended recipient.

### SUMMARY

An embodiment of the present invention includes an asynchronous electronic communication system and method configured for secured communication between a first party and a second party. The secured communication occurs without a need for pre-arrangement of shared static encryption key secrets between these parties. Moreover, there is no need for contemporaneous communications for the exchange to occur.

By way of example, in one embodiment a third party, e.g., an authentication and key system, receives an initiation request for authentication from a first party, e.g., a sender, seeking to transmit electronic content (e.g., a document, a message, file, or any other information) to a second party, e.g., a recipient. The system generates an asymmetric key set, which includes a private key and a public key that are associated with a key reference. The system stores the private key in a database with the key reference and transmits the public key to the sender. The sender uses the public key to encrypt the document to be sent to the recipient. The system will then receive a request for the private key from a recipient of the encrypted electronic content. The system will authenticate the recipient identity. Once authenticated, the system transmits the private key to the recipient. The recipient then uses the private key to decrypt the encrypted electronic content.

An embodiment of the present invention includes linking user authentication with the generation and distribution of dynamic and one-time use encryption key secrets. Only a sender authenticated with a host can request from a key management authority, which is a neutral third party, to generate a dynamic encryption key pair. The key management authority sends the sender the public key of this dynamic encryption key pair and stores the private key in secrecy with a key reference. When the recipient receives the encrypted electronic content, the recipient can request the key management authority to authenticate the recipient itself. Upon successful authentication, the key management system transmits the private key to the recipient to decrypt the encrypted electronic content.

In one embodiment, a user authentication mechanism is considered separately. It can be a traditional “user identification (ID) and password” system or a more secure one-time password two-factor authentication system. The two factors refer to “what you know” and “what you have”. The “what you know” factor is a password or a personal identification number (PIN). The “what you have” factor is a personal belonging of a user. The personal belonging is typically a tangible device that can function as a token device. Examples include a personal computer, a mobile phone or smartphone, a personal digital assistant, or a standalone separate hardware token device. These devices provide a generated one-time password or digital signature in response to being triggered by the application of the first factor. The one-time password or digital signature is then used for accessing the secured information.

The present invention includes a number of advantages. For example, it offers user friendliness because users are dealing with authentication rather than encryption. Most users are quite familiar with user authentication in their day to day interactions, particularly with their personal belongings. For example, logging onto their work computer system or onto a web site from a computer system, smartphone, personal digital assistant or mobile phone.

Another advantage is system and method flexibility and extensibility. The system and method may be configured for use with a common “user ID and password” system so that user are already familiar with it. Alternatively, the system and method may enhance the authentication part by adding two-factor verification. In either instance, the complexity of the encryption mechanism is transparent to users and does not unnecessarily burden them with its use.

Another advantage is the way keys are handled. First, the encryption key pair is generated dynamically and used only once for each data file. Second, the decryption key and the encrypted data file never come together in the same place. Third, the recipient does not have knowledge of the decryption key (i.e., the private key) before the key management authority authenticates the recipient. Fourth, the identity of the sender and the recipient are authenticated and both the sender and the recipient know the other party is a genuine one.

The features and advantages described herein provide a beneficial use to those making use of a system and a method as described in embodiments herein. For example, a user is provided mechanisms, e.g., by receiving and/or transmitting control signals, to control access to particular information as described herein. Further, these benefits accrue regardless of whether all or a portion of components, e.g., server systems, to support their functionality are located locally or remotely relative to the user.

In addition, the features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The disclosed embodiments have other advantages and features which will be more readily apparent from the following detailed description and the appended claims, when taken in conjunction with the accompanying drawings, in which:

FIG. 1 illustrates one embodiment of a secured transaction framework in accordance with the present invention.

FIG. 2 illustrates one embodiment of a secured transaction system architecture in accordance with the present invention.

FIG. 3 illustrates one embodiment of a process for communication between a sender and a secured authentication and key system in accordance with the present invention.

FIG. 4 illustrates one embodiment of a process for communication between a recipient and a secured authentication and key system in accordance with the present invention.

### DETAILED DESCRIPTION

The Figures (FIGS.) and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments, examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles described herein.

Generally, the disclosed embodiments describes a secured management system which removes the necessity for pre-arrangement of mutually agreed “encryption keys” that are shared between sender and recipient. In addition, the secured transport of data and/or content provides a platform that works with established and proven cryptographic algorithms. In one embodiment, asynchronous encryption allows for cryptographic algorithm independence that permits flexible upgrades or proprietary extensions by third parties.

Secured Transaction Framework

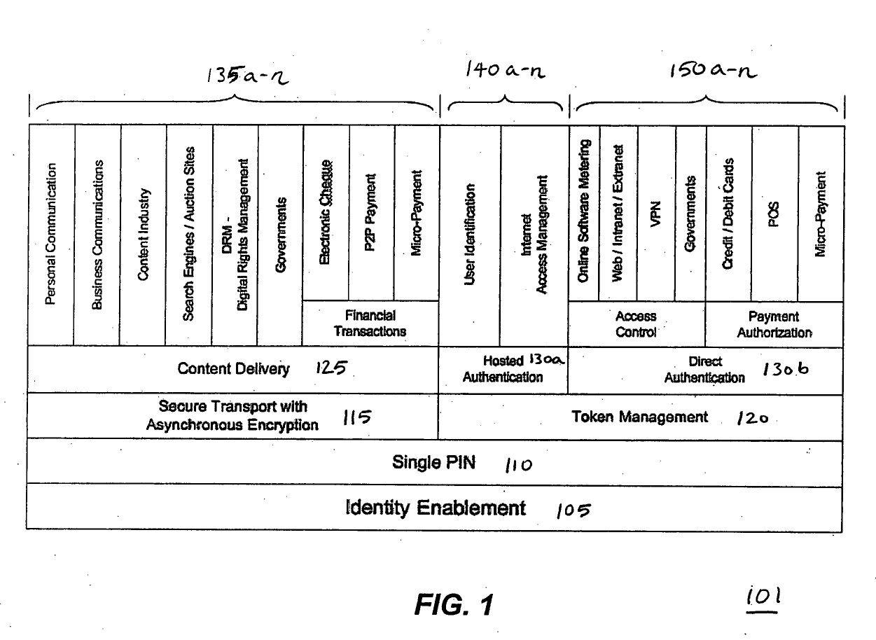

FIG. 1 illustrates one embodiment of a secured transaction framework 101 in accordance with the present invention. At the foundation of a secured transaction framework is identity enablement 105. Identity enablement 105 refers to an individual preparing for secured access to information. On top of identity enablement 105 is a single personal identification number (PIN) 110 that is a gateway for the individual identified in identity enablement 105 to get access to additional services within the framework 101. The PIN can be one or more numbers (e.g., 0-9), alpha characters (e.g., A-Z), special characters (e.g., @, #, %, etc.), or a combination of any of these. One example of a single PIN 110 configuration is described in co-pending U.S. patent application No. ______, filed Mar. 15, 2006, titled “Single One-Time Password Token with Single PIN for Access to Multiple Providers” by the same inventors as the present application, which claims a benefit of U.S. provisional patent application No. 60/748,061, filed Dec. 6, 2005, and titled “Single One-Time Password Token with Single PIN for Access to Multiple Providers” by the same inventors as the present application, each application herein incorporated by reference.

On top of the single PIN 110 are a secure transport with asynchronous encryption 115 and token management 120. On top of the secure transport with asynchronous encryption 115 is content delivery 125. Content delivery 125 includes content for delivery between parties (e.g., a sender and a recipient) based on what application 135a-n (generally) the communication is with or through. In the context of content delivery 125, communications may be between applications 135 that involve, for example, end users (e.g., electronic mail (e-mail)), business users (e.g., B2B and B2C), the content industry itself (e.g., music or movie download), search engines, commerce sites (e.g., on-line shopping or auctions), government agencies (e.g., access personal Medicare information), or digital rights management mechanisms (e.g., keys for accessing secured content). In the context of content delivery 125 that includes a financial transaction, additional security may be integrated, e.g., secured web site, for transactions such as person-to-person direct fund transfer, e-cheques, or micro-payments.

On top of token management 120 is verification services (generally 130) that can be provided as a hosted authentication model 130a or a direct authentication model 130b. Depending on the model, additional applications that involve, for example, user identification or Internet access management (e.g., privacy/parental control) in the case of hosted authentication model 130a. For a direct authentication model the applications may involve access control (e.g., corporate access management and virtual private networks, or government agency access) or payment authorization (e.g., credit/debit cards, point of sale or micro-payments).

The description herein provides a system and a method for further enabling the security framework. For ease of understanding, the description may be in the context of electronic communication between a sender and a recipient. However, the principles described herein are equally applicable for any transaction between parties, e.g., a buyer and a seller or a login requester and secured web site operator, and other applications between parties as noted above.

Secured Transaction System

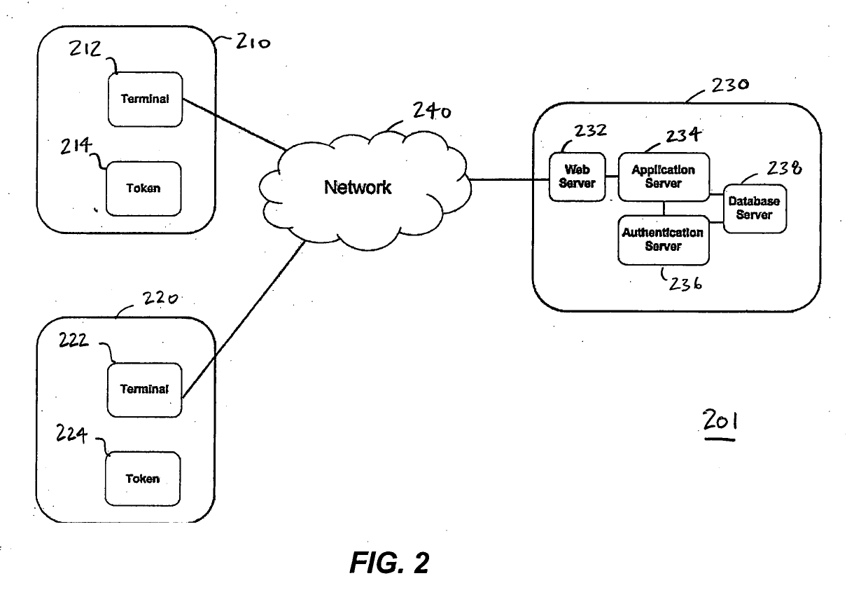

FIG. 2 illustrates one embodiment of a secured transaction system architecture 210 in accordance with the present invention. The secured transaction system includes a first party 210, a second party 220 and a third party 230. The first party 210, the second party 220, and the third party 230 are communicatively coupled through a network 240. In an example of a general operational structure, the third party 230 authenticates the first party 210 and the second party 220 and for the third party 230 to generate single use key pair, to supply encryption key to the first party 210 and to supply decryption key to the second party 220.

In one embodiment, the first party 210 may comprise a terminal 212 and a token 214. The terminal 212 is a computing device equipped and configured to communicate with the second party 220 and the third party 230 through the network 240. Examples of the terminal 212 include a personal computer, a laptop computer, or a personal digital assistant (PDA) with a wired or wireless network interface card or a smartphone or a mobile phone with a cellular access. The token 214 is a security mechanism that provides a password, e.g., a one-time password, or a digital signature. The token 214 may be a standalone separate physical device or may be an application or applet running on the terminal 212 or a separate standalone physical device (e.g., a mobile phone or personal digital assistant).

In one embodiment, the terminal 212 and the token 214 function together to form a user authentication mechanism. It can be a traditional “user identification (ID) and password” system that most users are familiar with (e.g., a computer logon with a password) or a more secure one-time password two-factor authentication system. Note that the user ID can be any unique identifier, for example, an electronic mail (e-mail) address, a telephone number, or a personal identity code or number (e.g., member number, employee number).

In the latter configuration, the two factors refer to “what you know” and “what you have”. The “what you know” factor is a password or a personal identification number (PIN) as previously described. The “what you have” factor is a personal belonging of a user. The personal belonging is typically a tangible device that can function as the token 214. Examples include a personal computer, a mobile phone or smartphone, a personal digital assistant, or a standalone separate hardware token device. The token 214 provides a generated one-time password or digital signature in response to being triggered by the application of the first factor, i.e., the PIN. The one-time password or digital signature is then used for accessing secured information as is further described herein.

A configuration similar to the first party 210 comprises the second party 220 and its terminal 222 and token 224. In addition, the network 240 may be a wired or wireless network. Examples of the network 240 include the Internet, an intranet, a cellular network, or a combination thereof. It is noted that the first-party system 210 and second-party system 220 are structured to include a processor, memory, storage, network interfaces, and applicable operating system and other functional software (e.g., network drivers, communication protocols, etc.).

The third party (or security management system or secured authentication and key system), 230 includes a web server 232, an application server 234, an authentication server 236, and a database server 238. The web server 232 communicatively couples the network 240 and the application server 234. The application server 234 communicatively couples the authentication server 236 and the database server 238. The authentication server 236 also communicatively couples the database server 238.

The web server 232 is a front end into the third-party system 230 and functions as a communication gateway into the third-party system 230. It is noted that the web server 232 is not limited to an Internet web server, but rather can be any communication gateway that appropriately interfaces the network 240, e.g., a corporation virtual private network front end, a cell phone system communication front end, or a point of sale communication front end. For ease of discussion, this front end will be referenced as a web server 232, although the principles disclosed are applicable to a broader array of communication gateways.

The application server 234 is configured to manage communications relating to user profiles and token identifiers between the first party 210, the second party 220 and the authentication server 236. The authentication server 236 is configured to encrypt and decrypt token secrets and parameters, verify passwords or digital signatures, and generate keys for use by the first party 210 and the second party 220. The database server 238 is configured to store applications, data and other encrypted information from the application server 234 and the authentication server 236.

In one embodiment, security may be enhanced through a “principle of segregation of secrets”. In particular, the application server 234 has access to user profiles and token identifiers and the authentication server 236 has privileged access to the encrypted token secrets and parameters based on the given token identifiers by the application server 234. A token identifier for a user profile (of the first party 210 or the second party 220) is an identification number or pointer to the actual token secrets and parameters for the corresponding user profile.

It is noted that the third-party system 230 can be configured on one or more conventional computing systems having a processor, memory, storage, network interfaces, peripherals, and applicable operating system and other functional software (e.g., network drivers, communication protocols, etc.). In addition, it is noted that the servers 232, 234, 236, and 238 are logically configured to function together and can be configured to reside on one physical system or across multiple physical systems.

In one embodiment, operation of the secured transaction system 201 can be described as follows. The first party 210 through its terminal 212 seeks to connect with the web server 232 of the third party 230 through the network 240 in order to request authentication. The web server 232 passes the authentication request to the application server 234. The application server 234 searches for a token identifier corresponding to the first party 210 in the database server 236. Once the token identifier is located, the application server 234, through the web server 232 and the network 240, sends a request to the terminal 212 of the first party 210 to submit a one-time password or digital signature.

In response to the request from the application server 234 of the third party 230, the first party 210 uses its token 214 to compute a one-time password or digital signature. Through the terminal 212, the first-party submits the computed one-time password or digital signature to the application server 234 of the third party 230 via the network 240 and the web server 232. The application server 234 receives the one-time password or digital signature and forwards it along with the previously retrieved token identifier to the authentication server 236.

The authentication server 236 retrieves the encrypted token secrets and current token parameters from the database server 238. In one embodiment, token secrets comprise cryptographic keys, random numbers, control vectors and other secrets for computation and cryptographic operations by the token 214 and by the authentication server 236. In addition, token parameters comprise control parameters, for example, encrypted PIN, a monotonically increasing or decreasing sequence number, optional transaction challenge code, transaction digests and usage statistics. In some embodiments, the token parameters may be dynamic such that they will be updated upon authentication operations. The authentication server 236 then decrypts the token secrets and token parameters and uses the information to verify the one-time password or digital signature received from the first party 210.

Verification is usually done through a predefined algorithm consisting of programmed computational steps and cryptographic operations. For example, the authentication server 236 would derive a prediction index to the monotonically increasing sequence number from the given one-time password of the first party 210. Based on the predicted sequence number, the authentication server 236 can feed the corresponding token secrets and parameters into a pre-defined one-time password cryptographic algorithm to compute a one-time password. Verification is successful if the computed one-time password and the given one-time password match. Upon successful verification, the authentication server 236 generates a set of paired keys that include one encryption key and one decryption key. The authentication server 236 returns the encryption key to the terminal 212 of the first party 210 via the application server 234, web server 232 and the network 240.

It is noted that in alternative embodiments, the authentication server 236 may generate more than one set of key pairs for the first party 210 that may be used when the terminal 212 of the first party 210 is offline from the network 240 and/or the web server 232. In this alternative embodiment, the multiple encryption keys are returned to the terminal 212 and stored in a storage device of the terminal 212.

Using the encryption key from the third party 230, the first party 210 encrypts electronic content (e.g., a document, a file, a message, a stream or other information). The encrypted electronic content is then transmitted (or sent) to the second party 220. It is noted that the transmission of the encrypted electronic content can be via an electronic medium, for example, e-mail, short message service, instant messenger, or web site. Alternatively, delivery of the encrypted electronic content can be through physical delivery, for example, delivery of an optical disk (e.g., compact disc, DVD) or solid stage storage (e.g., a flash memory drive). In alternative embodiments, the first party 210 may encrypt two or more electronic contents using two or more encryption keys obtained from the third party 230. The two or more encrypted electronic contents are then transmitted to two or more other parties that are in communication with the first party 210.

When the second party 220 receives the encrypted electronic contents at its terminal 222, it decrypts the contents to gain access to the underlying content. To do this, the second party 220 uses the terminal 222 to connect to the web server 232 of the third party 230 via the network 240 to request authentication. The web server 232 passes the authentication request to the application server 234. The application server 234 searches for a corresponding token identifier of the second party 220 in the database server 238. If the second party 220 is a registered user, the token identifier is a pointer to the actual token secrets and parameters and can be readily retrieved from the database server 238.

If the second party 220 is not a registered user, the application server 234 will invite the second party 220 to register. The registration procedure will require verification of the authenticity of unique identification such as email address and optionally cell phone number of the second party 220, resulting in the creation of a unique token identifier and a new token dataset (containing token secrets and parameters) for the second party 220 upon successful registration. Once the token identifier is located in the database server 238, the application server 234, via the web server 232 and network 240, sends a request to the second party 220 to submit a one-time password or digital signature.

The terminal 222 of the second party 220 receives the request of the application server 234. The second party 220 uses the token 224 to compute the one-time password or digital signature. Through the terminal 222, the second party 220 submits the computed one-time password or digital signature to the application server 234 of the third party 230 via the network 240 and web server 232. The application server 234 receives the one-time password or digital signature and forwards it along with the previously retrieved token identifier to the authentication server 236.

The authentication server 236 retrieves the encrypted token secrets and the current token parameters from the database server 238. In one embodiment, token secrets include cryptographic keys, random numbers, control vectors and other secrets for computation and cryptographic operations by the token 224 and by the authentication server 236. Likewise, in one embodiment, token parameters include control parameters such as encrypted PIN, a monotonically increasing or decreasing sequence number, optional transaction challenge code, transaction digests and usage statistics. In some embodiments, some of the token parameters may be dynamic and may be updated upon authentication operations.

Using the one-time password or digital signature and according to the token identifier, the authentication server 236 decrypts the token secrets and token parameters and verifies the one-time password or digital signature received from the second party 220. Verification is usually done through a predefined algorithm comprised of programmed computational steps and cryptographic operations. For example, the authentication server 236 would derive a prediction index to the monotonically increasing sequence number from the given one-time password of the second party 220. Based on the predicted sequence number, the authentication server 236 can feed the corresponding token secrets and parameters into a pre-defined one-time password cryptographic algorithm to compute a one-time password. Verification is successful if the computed one-time password and the given one-time password match.

Upon successful verification, the authentication server 236 returns the decryption key of the key pair that was previously generated for the terminal 212 of the first party 210 via the application server 234, the web server 232 and the network 240 to the terminal 222 of the second party 220. If the second party 220 is offline, authentication of the identity of the second party 220 by the third party 230 is not possible and the second party 220 is not able to retrieve the decryption key. This arrangement helps ensure that only the authenticated and intended second party 220 can retrieve the decryption key to successfully decrypt the encrypted contents from the first party 210. Without successful authentication of the second party 220, the decryption key is not exposed outside the security perimeter of the third party 230.

Using the received decryption key, the terminal 222 of the second party 220 decrypts the encrypted electronic contents. The underlying content is now accessible to the second party 220. It is noted that the system can be further configured so that once the decryption key is sent to the second party 220, the set of paired keys, i.e., the previously generated encryption and decryption keys, can be voided or discarded so that they may not be used to decrypt and maliciously used in subsequent communications between the first party 210 and the second party 220. Each communication between the parties will have a fresh set of keys generated and appropriately transmitted as previously described. Optionally, it also is possible to store the used decryption keys in the database server 238 if the second party 220 requests a key escrow service from the third party 230. The key escrow allows the second party 220 to recover used encrypted contents from archive storage of the second party 220.

The configuration described includes a number of advantages. For example, it offers user friendliness because the parties 210, 220 (e.g., the users) interface with authentication rather than encryption. Most users are quite familiar with user authentication in their day to day interactions, particularly with their personal belongings. For example, logging onto their work computer system or onto a web site from a computer system, smartphone, personal digital assistant or mobile phone.

Another advantage is system flexibility and extensibility. It can be configured for use with the most common “user ID and password” system so that parties 210, 220 have immediate familiarity with the authentication process. Further, authentication can be enhanced by adding two-factor verification. In either instance, the complexity of the encryption mechanism is transparent to parties 210, 220 and does not unnecessarily burden them with its use.

Another advantage is key handling. First, the encryption key pair is generated dynamically and used only once for each data file. Second, the decryption key and the encrypted data file never come together in the same place. Third, the second party 220 does not have knowledge of the decryption key (i.e., the private key) before the third party 230 authenticates the second party 220. Fourth, the identities of the first party 210 and the second party 220 are authenticated and both the first party 210 and the second party 220 know the other party is genuine. Hence, the overall scheme provides a high level of security.

Secured Communications Example

The principles described herein can be further illustrated through an example of a secured electronic mail (email) communication process. In this example, there is a sender, a receiver, and a secured authentication and key system. The sender is functionally similar to the first party 210, the recipient is functionally similar to the second party 220, and the secured authentication and key system is functionally similar to the third party 230. The processes described with respect to these parties are performed on the respective terminal, computing system, and/or token as previously described. Communication between the sender or recipient and the secured authentication and key system is through a network functionally similar to the network 240. Communication between the sender and receiver is also through the network 240 in this example.

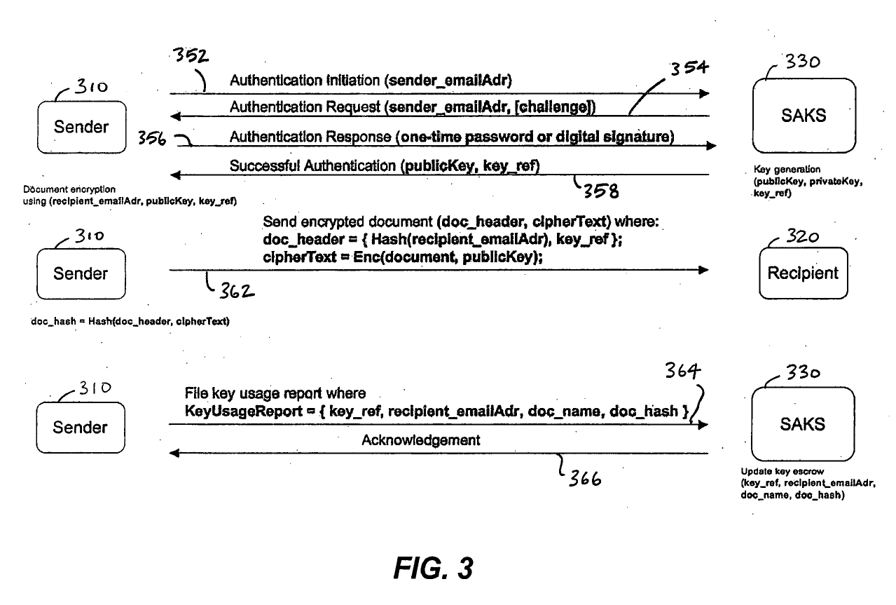

FIG. 3 illustrates one embodiment of a process for communication between a sender 310 and a secured authentication and key system 330. The process starts with authentication of the identity of the sender 310. The sender 310 initiating 352 authentication by sending to the secured authentication and key system 330 its email address (or other unique user identification) along with 356 its password that can be a one-time password, digital signature or a static password. If the secured authentication and key system 330 uses basic “user ID and password” authentication, the secured authentication and key system 330 verifies the static password given by the sender 310. If appropriately verified, the secured authentication and key system 330 generates a set of paired keys. The secured authentication and key system 330 stores a private key with a key reference in the database and transmits 358 back to the sender 310 a successful authentication message with the public key and key reference.

If the secured authentication and key system 330 is configured for optional “two factor” authentication, there are two authentication modes, namely simple mode and challenge-response mode. For the simple mode, the secured authentication and key system 330 verifies the one-time password or digital signature given by the sender 310 where the one-time password or digital signature was generated through the token of the sender 310.

For the challenge-response mode, the authentication initiation 352 does not include a password 356 from the sender 310. The secured authentication and key system 330 transmits 354 back to sender 310 an authentication request that includes a “challenge” code, e.g., a random number from the secured authentication and key system 330 used for enhanced security. In response to the request and the challenge code, the sender 310 uses its token to generate a one-time password or digital signature. The sender 310 transmits 356 a response to the secured authentication and key system 330 that includes this generated one-time password or digital signature.

The secured authentication and key system 330 uses the received one-time password or digital signature to verify the sender 310. If appropriately verified, the secured authentication and key system 330 generates a set of paired keys comprised of a key reference, a private key and a public key. The secured authentication and key system 330 stores a private key with a key reference in the database and transmits 358 back to the sender 310 a successful authentication message with the public key and the key reference. Upon receipt of the public key, the sender 310 uses it to encrypt electronic content (e.g., a message, a file, a document, or other information) to be transmitted to a recipient 320. For ease of discussion, this example will reference encryption of a document.

In one embodiment, the document is encrypted into a file that includes a document header and a cipher text encrypted from the document itself. The document header is comprised of a hash of the recipient 320 email address and the key reference. To ensure data integrity, the whole encrypted file also is hashed. The encrypted file (or document for ease of discussion) is then transmitted 362 to the recipient 320.

Once the sender 310 transmits the encrypted document to the recipient 320, the sender 310 generates a key usage report. The key usage report includes the key reference, recipient 320 email address, the document name, and the document hash of the whole encrypted file. The key usage report is transmitted 364 to the secured authentication and key system 330. The secured authentication and key system 330 optionally may transmit 366 back to the sender 310 an acknowledgement of the received key usage report.

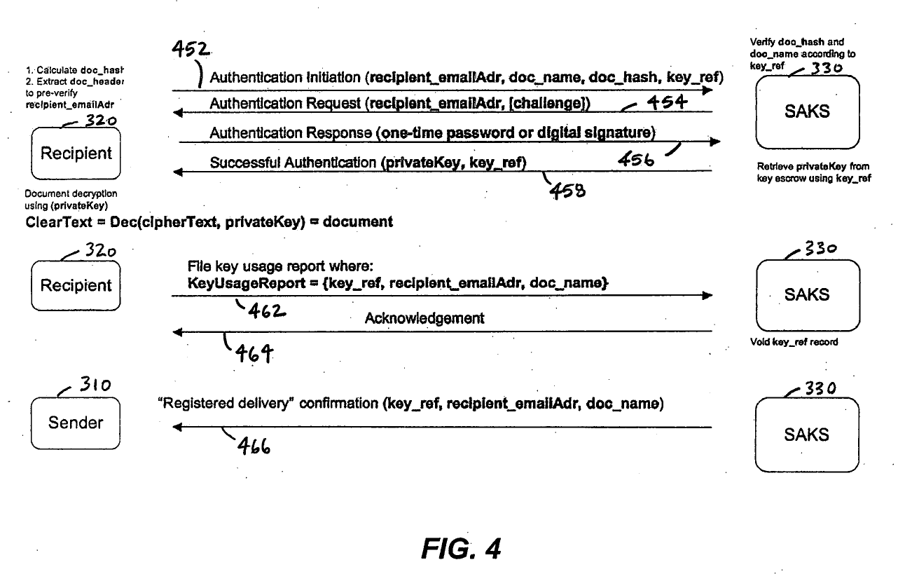

FIG. 4 illustrates one embodiment of a process for communication between the recipient 320 and the secured authentication and key system 330 in accordance with the present invention. When the recipient 320 receives the encrypted document from the sender 310, the recipient calculates the document hash and extracts the document header to pre-verify the recipient email address in it. Pre-verification of the recipient 320 email address with the corresponding hashed value in the document header ensures that the recipient 320 is the intended recipient. If pre-verification fails (e.g., the recipient 320 given email address does not match with the corresponding hashed value in the document header), the recipient 320 is not allowed to proceed opening the encrypted file.

Upon successful pre-verification, the recipient 320 initiates 452 authentication with the secured authentication and key system 330. Specifically, the recipient 320 transmits its email address, the document name, the document hash and the key reference together with 456 its password that can be a one-time password, digital signature or a static password to the secured authentication and key system 330. If two-factor authorization is not used, the secured authentication and key system 330 verifies the static password, the document hash and document name based on the key reference that it received from the recipient 320 and that was previously stored in the database.

If the secured authentication and key system 330 is configured for optional “two factor” authentication, there are two authentication modes, namely simple mode and challenge-response mode. For the simple mode, the secured authentication and key system 330 verifies the-one-time password or digital signature given by the recipient 320 and the one-time password or digital signature was generated through the token of the recipient 320.

For the challenge-response mode, the authentication initiation 452 does not include a password 456 from the recipient 320. The secured authentication and key system 330 transmits 454 back to recipient 320 an authentication request that includes a “challenge” code, e.g., a random number from the secured authentication and key system 330 used for enhanced security. In response to the request and the challenge code, the recipient 320 uses its token to generate a one-time password or digital signature.

The recipient 320 transmits 456 a response to the secured authentication and key system 330 that includes this generated one-time password or digital signature. The secured authentication and key system 330 uses the received one-time password or digital signature to verify the recipient 320. If appropriately verified, the secured authentication and key system 330 verifies the document hash and document name based on the key reference that it received from the recipient 320 with the corresponding items that was previously stored in the database.

Once the document hash and document name are verified with respect to the key reference, the secured authentication and key system 330 retrieves from its database the private key that was previously stored with the key reference. The secured authentication and key system 330 transmits 458 the private key and the key reference back to the recipient 320. The recipient 320 applies the private key to the cipher text to decrypt the document. The recipient 320 can now review the document (and/or other content that was encrypted using the process).

With the document decrypted, a file key usage report is transmitted 462 to the secured authentication and key system 330. The file key usage report includes the key reference, the recipient 320 email address, and the document name. When the secured authentication and key system 330 receives this report it voids (or deletes) the key reference records from its database. The secured authentication and key system 330 may send 464 back an optional acknowledgement to the recipient 320. The secured authentication and key system 330 also may notify the sender 310 of delivery by transmitting 466 to the sender an optional registered delivery confirmation that includes the key reference, the recipient 320 email address and the document name. Hence, the sender 310 is able to confirm, and in essence have assurances, that the document was transmitted and reviewed by the genuine and intended recipient 320.

A benefit of the example provided is that a system and a method in accordance with it allows an authenticated sender to encrypt electronic contents that can only be decrypted by the intended and authenticated recipient without the need to preset keys between the sender and the recipient. Hence, the encryption process is ‘asynchronous’ because there is no requirement to preset keys between the sender and the recipient. This simplifies ease of use without unnecessarily burdening users while increasing overall security.

Further, the features and advantages described in the specification provide a beneficial use to those making use of a system and a method as described in embodiments herein. For example, a user is provided mechanisms, e.g., by receiving and/or transmitting control signals, to control access to particular information as described herein. Further, these benefits accrue regardless of whether all or portions of components, e.g., server systems, to support their functionality are located locally or remotely relative to the user.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Various embodiments may be implemented using one or more hardware elements. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. The embodiments are not limited in this context.

Various embodiments may be implemented using one or more software elements. In general, a software element may refer to any software structures arranged to perform certain operations. In one embodiment, for example, the software elements may include program instructions and/or data adapted for execution by a hardware element, such as a processor. Program instructions may include an organized list of commands comprising words, values or symbols arranged in a predetermined syntax, that when executed, may cause a processor to perform a corresponding set of operations. The software may be written or coded using a programming language. Examples of programming languages may include C, C++, BASIC, Perl, Matlab, Pascal, Visual BASIC, JAVA, ActiveX, assembly language, machine code, and so forth. The software may be stored using any type of computer-readable media or machine-readable media. Furthermore, the software may be stored on the media as source code or object code. The software may also be stored on the media as compressed and/or encrypted data. Examples of software may include any software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Some embodiments may be implemented, for example, using any computer-readable media, machine-readable media, or article capable of storing software. The media or article may include any suitable type of memory unit, memory device, memory article, memory medium, storage device, storage article, storage medium and/or storage unit, such as any of the examples described with reference to a memory. The media or article may comprise memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), subscriber identify module, tape, cassette, or the like. The instructions may include any suitable type of code, such as source code, object code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, JAVA, ActiveX, assembly language, machine code, and so forth. The embodiments are not limited in this context.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of embodiments of the present invention. This was done merely for convenience and to give a general sense of the embodiments of the present invention. This description should be read to include one or at least one and the singular also includes the plural unless it is obvious that it is meant otherwise.

Upon reading this disclosure, those of skill in the art will appreciate still additional alternative structural and functional designs for a system and a process for asynchronous encryption for secured electronic communication between parties through the disclosed principles herein. Thus, while particular embodiments and applications have been illustrated and described, it is to be understood that the present invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. An asynchronous electronic communication method comprising:
receiving, from a sender of a message, an initiation request for authentication;
generating an asymmetric key set having a key reference and comprising a private key and a public key;
storing the private key in a database with the key reference;
transmitting the public key to the sender, the public key for encrypting the message;
receiving a request from a recipient of the encrypted message for the private key;
authenticating an identity of the recipient; and
transmitting, in response to the recipient being authenticated, the private key to the recipient, the private key for decrypting the encrypted message.

2. The method of claim 1, further comprising voiding the key reference, the private key and the public key from the database in response to transmitting the private key.

3. The method of claim 1, wherein receiving the initiation request further comprises:
transmitting an authentication request to the sender; and
receiving a response to the authentication request.

4. The method of claim 1, further comprising:
receiving a registration request from the recipient in response to the recipient not being registered to receive the private key; and
receiving registration information from the recipient prior to transmitting the private key.

5. The method of claim 1, further comprising transmitting delivery notification to the sender in response to transmitting the private key to the recipient.

6. A computer readable medium configured to store instructions executable by a processor, the instructions when executed by the processor to cause the processor to:
receive, from a sender of a message, an initiation request for authentication,
generate an asymmetric key set having a key reference and comprising a private key and a public key,
store the private key in a database with the key reference, and
transmit the public key to the sender, the public key for encrypting the message.

7. The computer readable medium of claim 6, further comprising instructions that for to cause the processor to:
receive a request from a recipient of the encrypted message for the private key;
authenticate an identity of the recipient; and
transmit, in response to the recipient being authenticated, the private key to the recipient, the private key for decrypting the encrypted message.

8. The computer readable medium of claim 7, wherein the instructions to authenticate the identity of the recipient further comprises instructions to verify a one-time password received from the recipient with a one-time password generated through a token of the recipient.

9. The computer readable medium of claim 7, wherein the instructions to authenticate the identity of the recipient further comprises instructions to issue a challenge in response to an authentication request from the recipient.

10. The computer readable medium of claim 7, wherein the instructions to authenticate the identity of the recipient further comprises instructions to receive a one-time password generated from a token of the recipient in response to the challenge.

11. An asynchronous electronic communication system comprising:
a receiver configured to receive an initiation request for authentication from a sender of a message and configured to receive a request from a recipient of an encrypted message for a private key;
a key generator configured to generate an asymmetric key set having a key reference and comprising the private key and a public key;
an authenticator configured to authenticate an identity of the recipient
a storage configured to store the private key in a database with the key reference; and
a transmitter configured to transmit the public key to the sender, the public key for encrypting the message, and configured to transmit the private key to the recipient, the private key for decrypting the encrypted message, in response to the recipient being authenticated.

12. The system of claim 11, wherein the authenticator is further configured to encrypt and decrypt token secrets and parameters corresponding to the recipient.

13. The system of claim 12, wherein the token secrets comprise at least one of cryptographic keys, random numbers, and control vectors.

14. The system of claim 12, wherein the token parameters comprise control parameters.

15. The system of claim 14, wherein the control parameters comprise at least one of an encrypted personal identification number and a sequence number.
